(19) United States
(12) Patent Application Publication
(10) Pub. No.: US 2025/0256594 A1
(43) Pub. Date: Aug. 14, 2025

(54) Electrical Assembly and Related Methods

(71) Applicant: Aptiv Technologies AG, Schaffhausen (CH)

(72) Inventors: Rachit Agarwal, Troy, MI (US); Sumit Dutta, Rochester Hills, MI (US)

(21) Appl. No.: 18/634,214

(22) Filed: Apr. 12, 2024

Related U.S. Application Data
(60) Provisional application No. 63/551,149, filed on Feb. 8, 2024.

(51) Int. Cl. B60L 53/20; B60L 1/00; B60L 53/14

(52) U.S. Cl. CPC B60L 53/20; B60L 1/006; B60L 53/14; B60L 2210/30

(57) ABSTRACT

An electrical assembly includes an onboard charger (OBC) and a power splitter. The OBC is configured to receive alternating current from a power source. The power splitter is electrically connected with the OBC and is configured to provide an output voltage. The electrical assembly is configured to simultaneously charge at least one battery and provide the output voltage.

### CROSS-REFERENCE TO RELATED APPLICATIONS

This application claims the benefit of U.S. Provisional Application No. 63/551,149 filed Feb. 8, 2024, the entire disclosure of which is incorporated by reference.

### FIELD

The present disclosure relates to an electrical assembly and more particularly to an electrical assembly that is configured to simultaneously charge a vehicle rechargeable energy storage system (RESS) and provide vehicle-to-load (V2L) power flow.

### BACKGROUND

Electric vehicles (EVs) are gaining popularity as environmentally friendly alternatives to traditional internal combustion engine vehicles. EVs are powered by rechargeable batteries, which require periodic charging to ensure continuous operation. Conventionally, EVs are equipped with on-board chargers that facilitate the charging of the vehicle's batteries by connecting to an external power source, such as a charging station or electrical outlet. Conventional on-board chargers are typically designed to focus solely on charging the vehicle's rechargeable energy storage system (RESS) and do not simultaneously charge a RESS and provide vehicle-to-load (V2L) power flow to power accessories or auxiliary devices such as onboard electronics, heating or cooling systems, or other auxiliary components connected to the vehicle. While known electrical assemblies, such as EV on-board chargers, have proven acceptable for their intended purpose, a continuous need for improvement remains in the pertinent art.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

One aspect of the disclosure provides an electrical assembly. The electrical assembly includes an onboard charger (OBC) and a power splitter. The OBC is configured to receive alternating current from a power source. The power splitter is electrically connected with the OBC and is configured to provide an output voltage. The electrical assembly is configured to simultaneously charge at least one battery and provide the output voltage.

Another aspect of the disclosure provides an electrical assembly. The electrical assembly includes a power splitter configured to electrically connect to an onboard charger (OBC) and provide an output voltage. The OBC is configured to receive alternating current from a power source. The electrical assembly is configured to simultaneously charge at least one battery and provide the output voltage.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is a high-level schematic view of an example electrical assembly in accordance with the principles of the present disclosure.

FIG. 2 is a schematic view of an example onboard charger of an electrical assembly in accordance with the principles of the present disclosure.

FIG. 3 is a schematic view of an example first power splitter of an electrical assembly in accordance with the principles of the present disclosure.

FIG. 4 is a schematic view of an example second power splitter of an electrical assembly in accordance with the principles of the present disclosure.

FIG. 5 is a schematic view of an example second power splitter of an electrical assembly in accordance with the principles of the present disclosure.

FIG. 6 is a schematic view of an example second power splitter of an electrical assembly in accordance with the principles of the present disclosure.

FIG. 7 is a flowchart depicting an example method for operating an electrical assembly in accordance with the principles of the present disclosure.

In the drawings, reference numbers may be reused to identify similar and/or identical elements.

### DETAILED DESCRIPTION

### Introduction

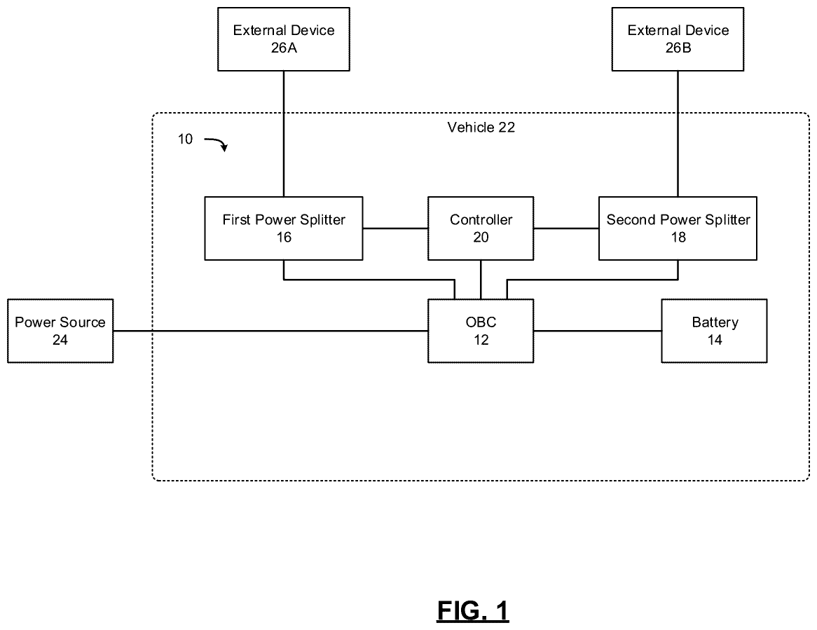

With reference to FIG. 1, an example electrical assembly 10 is shown. As will be explained in more detail below, the electrical assembly 10 may include an onboard charger (OBC) 12, at least one battery 14, a first power splitter 16, a second power splitter 18, and/or a controller 20, among others. In some example configurations, the electrical assembly 10 may include the first power splitter 16 and not the second power splitter 18. In some instances, the electrical assembly 10 may include the second power splitter 18 and not the first power splitter 16.

In various implementations, the OBC 12 may be electrically connected with the battery 14, the first power splitter 16, and/or the second power splitter 18. The controller 20 may be electrically connected with the OBC 12, the first power splitter 16, and/or the second power splitter 18. The electrical assembly 10 may be installed in and/or may be used in connection with a vehicle 22 (e.g., an automobile).

In various implementations, the OBC 12 is detachably connected with a power source 24 and may receive alternating current from the power source 24. In some examples, the OBC 12 may receive up to approximately 240 volts (V) alternating current (AC) (e.g., single phase or three phase) from the power source 24.

In various implementations, for single phase examples, the OBC 12 may receive approximately 48 amperes (A) of electrical current and/or approximately 11 kilowatts (kW) of power from the power source 24. In various implementations, the OBC 12 may receive more or less than 48 A of electrical current and/or 11 kW of power from the power source 24.

In various implementations, for three phase examples, the OBC 12 may receive approximately 16 A of electrical current per phase and/or approximately 11 kW of power from the power source 24. In various implementations, the OBC 12 may receive more or less than 16 A of electrical current per phase and/or approximately 11 kW of power from the power source 24.

In various implementations, the first power splitter 16 is electrically connected with the OBC 12 and is configured to provide a first output voltage (e.g., approximately 220V AC). In various implementations, a first external electrical device 26A (e.g., an electronic device such as a computer, laptop, phone, etc.) may be detachably connected with the first power splitter 16 and may receive the first output voltage from the first power splitter 16.

In various implementations, the second power splitter 18 is electrically connected with OBC 12 and is configured to provide a second output voltage (e.g., approximately 120V AC) that is different than the first output voltage. In various implementations, a second external electrical device 26B (e.g., an electronic device such as a computer, laptop, phone, etc.) may be detachably connected with the second power splitter 18 and may receive the second output voltage from the second power splitter 18.

In various implementations, the electrical assembly 10 simultaneously charges the at least one battery 14 and provides the first output voltage to an external electrical device (e.g., the first device 26A) or the second output voltage to an external electrical device (e.g., the second device 26B). For example, the OBC 12 converts the input alternating current from the power source 24 to direct current to charge the at least one battery 14. The first power splitter 16 may provide the first output voltage to an external electrical device (e.g., the first device 26A) when the first power splitter 16 is in an activated state. The second power splitter 18 may provide the second output voltage to an external electrical device (e.g., the second device 26B) when the second power splitter 18 is in an activated state.

### Onboard Charger

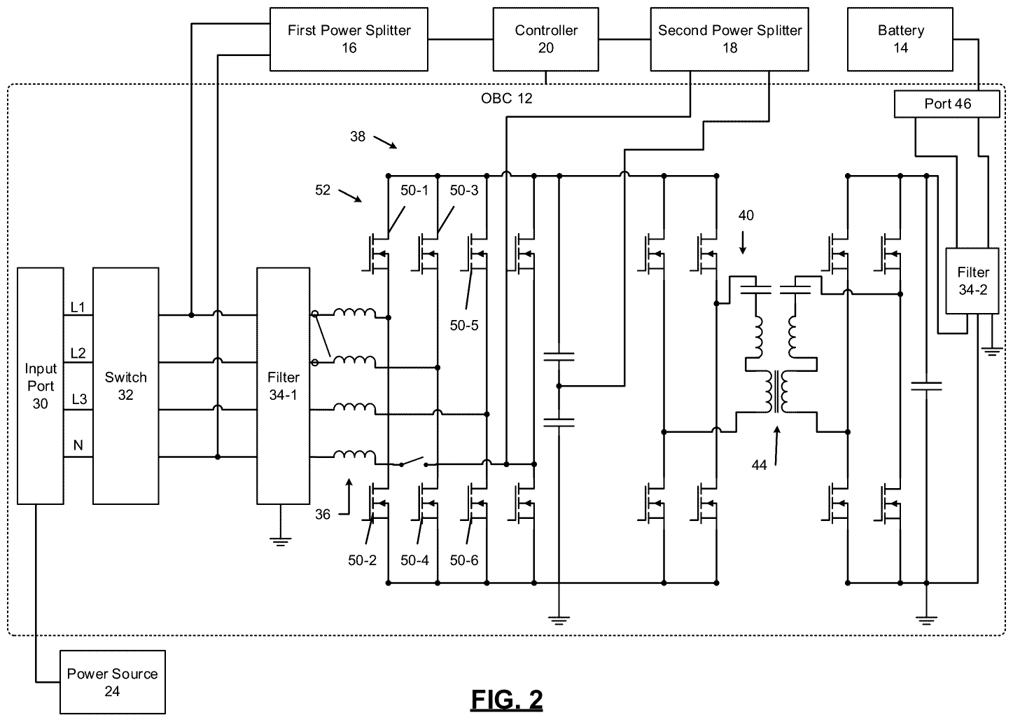

With reference to FIG. 2, an example OBC 12 is shown. In various implementations, the OBC 12 may be electrically connected with the at least one battery 14, the first power splitter 16, the second power splitter 18, and/or the controller 20, among others. The OBC 12 may be detachably coupled with the power source 24.

In various implementations, the OBC 12 may include an input port 30, at least one switch 32 (e.g., relay, etc.), a first filter 34-1 (e.g., an AC filter), a second filter 34-2 (e.g., a DC filter), a plurality of inductors 36, a plurality of transistors 38, a plurality of capacitors 40, a plurality of resistors, a transformer 44, and an output port 46, among others. The controller 20 may be electrically connected with and may control operation of at least some of the electrical components of the OBC 12 (e.g., the switch 32, the transistors 38, etc.).

In various implementations, the input port 30 may be removably connected with the power source 24 and may receive alternating electrical current from the power source 24. In various implementations, at least some transistors of the plurality of transistors 38 (e.g., transistors 50-1 to 50-6) may operate as and/or may define a rectifier 52 (e.g., a power factor correction rectifier). In some example configurations, the rectifier 52 may be electrically connected with the input port 30, the switch 32, the first filter 34-1, the second filter 34-2, the inductors 36, additional transistors of the plurality of transistors 38, the capacitors 40, the resistors, the transformer 44, and/or the output port 46, among others.

In various implementations, the rectifier 52 may convert the alternating current received from the power source 24 to direct current. The at least one battery 14 may be electrically connected with the output port 46 and may receive the direct current to charge. In some example configurations, the OBC 12 may provide approximately 7.2 kW of power to charge the at least one battery 14. The OBC 12 may provide more or less than 7.2 kW of power to charge the at least one battery 14.

### Battery

In various implementations, a battery 14 may include one or more battery packs. A battery pack may include a plurality of battery cells. In various implementations, the at least one battery 14 may supply electricity to electric motors, electrical systems, electrical components, and/or onboard electronics of the vehicle 22.

### First Power Splitter

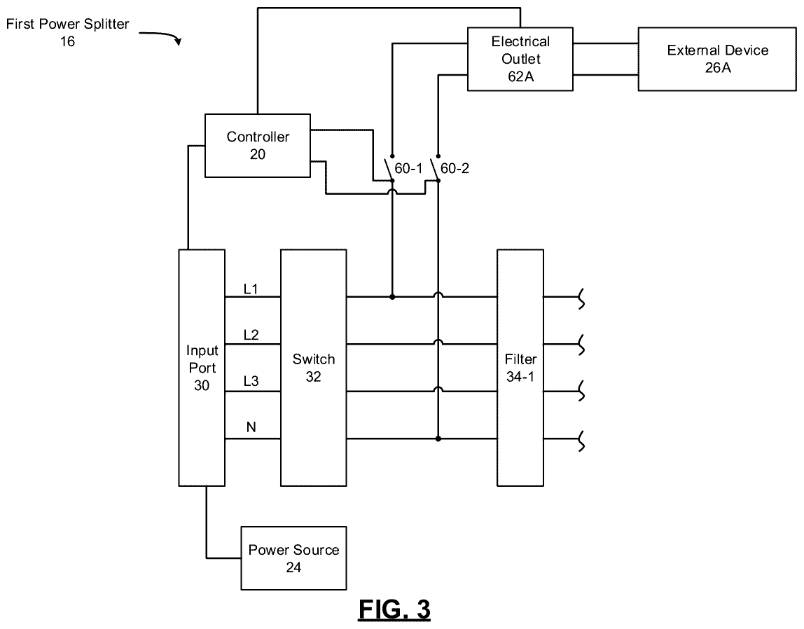

With reference to FIG. 3, an example first power splitter 16 is shown. In various implementations, the first power splitter 16 may be associated with and/or may facilitate compliance with the Combined Charging System (CCS) standard. In some example configurations, the first power splitter 16 may be an optional feature of the electrical assembly 10. The first power splitter 16 may be electrically connected with the input port 30 and the controller 20, among others.

In various implementations, the first power splitter 16 may include various electrical components such as a first switch 60-1 (e.g., a relay, etc.), a second switch 60-2 (e.g., a relay, etc.), and an electrical outlet 62A, among others. The first switch 60-1 and the second switch 60-2 may be electrically connected with the input port 30, the controller 20, and the electrical outlet 62A, among others.

In various implementations, an external electrical device 26A (e.g., a device that uses approximately 220 V AC to operate and/or charge) may be removably coupled with the electrical outlet 62A. The first power splitter 16 provides the first output voltage to the device 26A when the first power splitter 16 is in an activated state.

In various implementations, the controller 20 may control operation of the first power splitter 16 by selectively activating or deactivating the first power splitter 16. For example, the controller 20 may turn off or may turn on the first switch 60-1 and/or the second switch 60-2. The first switch 60-1 and the second switch 60-2 are in a closed configuration (e.g., turned on) when the first power splitter 16 is in an activated state. The first switch 60-1 and the second switch 60-2 are in an open configuration (e.g., turned off) when the second power splitter 18 is in an activated state.

In various implementations, during operation of the electrical assembly 10, the input port 30 may receive electrical current (e.g., approximately 48 A), input voltage (e.g., approximately 220 V), and/or input power (e.g., approximately 11 kW) from the power source 24. In accordance with an external electrical device (e.g., device 26A) being connected to the electrical outlet 62A and the first power splitter 16 being in an activated state, the first power splitter 16 may provide a first output voltage (e.g., approximately 220V AC), a first output current (e.g., approximately 15A AC), and/or a first output power (e.g., approximately 3.6 kW) to the external electrical device, while the OBC 12 simultaneously provides power (e.g., approximately 7.2 kW) to charge the at least one battery 14.

### Second Power Splitter

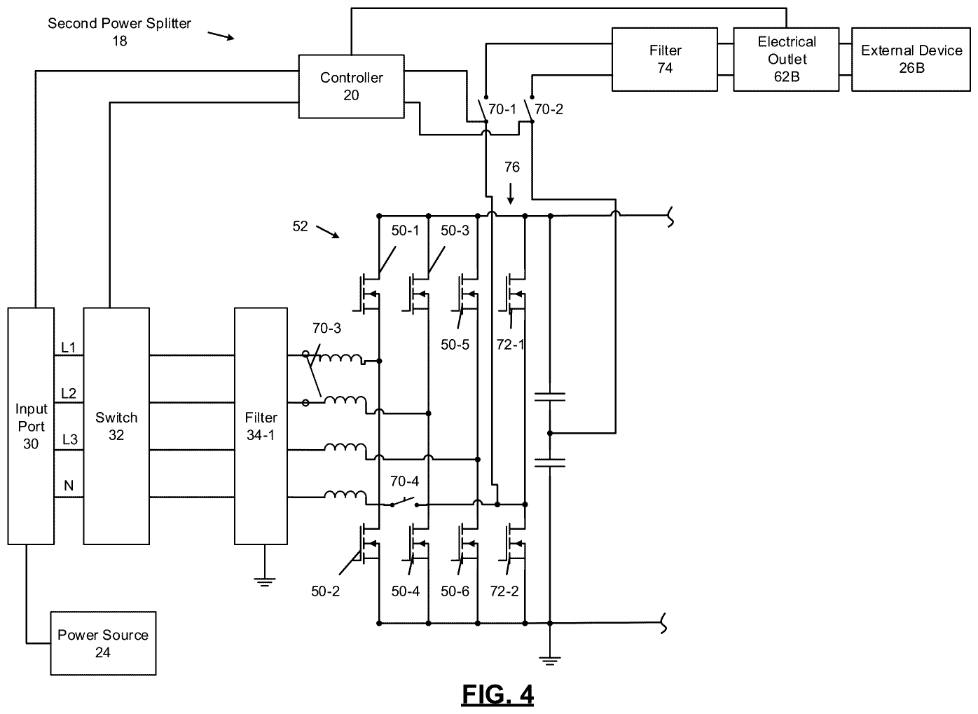

With reference to FIG. 4, an example second power splitter 18 is shown. In various implementations, the second power splitter 18 may be associated with and/or may facilitate compliance with the North American Charging Standard (NACS). In some example configurations, the second power splitter 18 may be an optional feature of the electrical assembly 10. The second power splitter 18 may be electrically connected with the input port 30, the OBC 12 (e.g., the rectifier 52), and the controller 20, among others.

In various implementations, the second power splitter 18 may include various electrical components such as a first switch 70-1 (e.g., a relay, etc.), a second switch 70-2 (e.g., a relay, etc.), a third switch 70-3 (e.g., a relay, etc.), a fourth switch 70-4 (e.g., a relay, etc.), a first transistor 72-1, a second transistor 72-2, a third transistor 72-3, a fourth transistor 72-4, a filter 74, and/or an electrical outlet 62B, among others.

In some example configurations, the second power splitter 18 may include an inverter 76. With continued reference to FIG. 4, in various implementations, the first transistor 72-1 and the second transistor 72-2 may operate as and/or may define the inverter 76 (e.g., a half-bridge inverter).

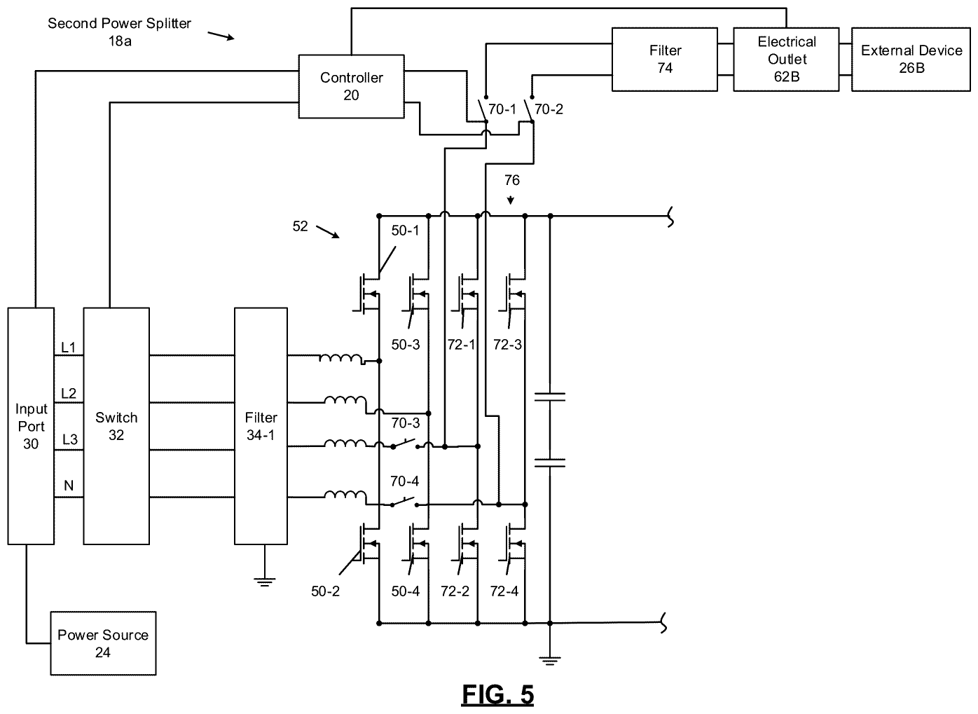

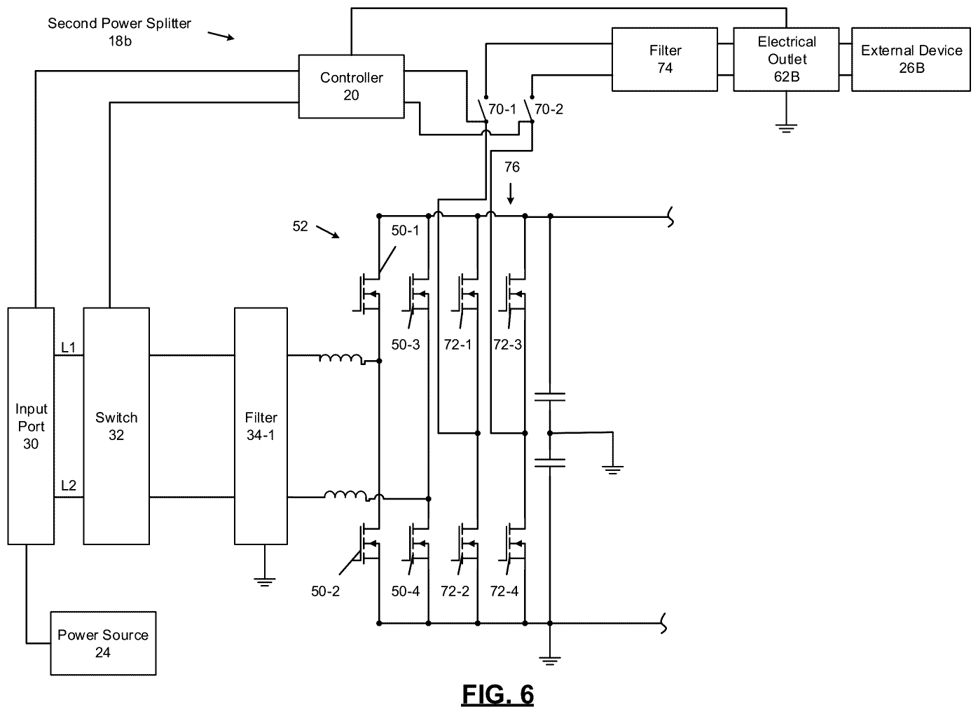

With reference to FIGS. 5 and 6, second power splitters 18a and 18b, respectively, are provided. In view of the substantial similarity in structure and function of the components associated with the second power splitter 18a, 18b relative to the second power splitter 18, like reference numerals are used hereinafter and in the drawings to identify like components, and references to the second power splitter 18 will be understood to apply equally to the second power splitter 18a or 18b unless otherwise indicated. In various implementations, the first transistor 72-1, the second transistor 72-2, the third transistor 72-3, and the fourth transistor 72-4 may operate as and/or define the inverter 76 (e.g., a full-bridge inverter). In various implementations, the inverter 76 may be electrically connected with the rectifier 52 and may convert direct current from the rectifier 52 to alternating current to produce the second output voltage (e.g., approximately 120 V AC).

In some example configurations, the first switch 70-1 and the second switch 70-2 may be electrically connected with the inverter 76 and the filter 74. The electrical outlet 62B may be electrically connected with the filter 74, the first switch 70-1, and the second switch 70-2. In various implementations, the third switch 70-3 and/or the fourth switch 70-4 may be electrically connected with the input port 30, the rectifier 52, and/or the inverter 76 (see, e.g., FIGS. 4 and 5).

In various implementations, each transistor (e.g., transistors 38, 50-1 to 50-6, and 72-1 to 72-4, etc.) may include a field effect transistor (FET), a metal oxide semiconductor field effect transistor (MOSFET), such as n-channel or p-channel MOSFET, a bipolar junction transistor (BJT), a smart FET, and/or a silicon die (e.g., bare silicon die), among others. Each transistor may include a closed (e.g., activated) state that may permit electrical current to flow through the respective transistor. Each transistor may include an open (e.g., deactivated) state that may prevent electrical current from flowing through the respective transistor.

In various implementations, an external electrical device 26B (e.g., a device that uses approximately 120 V AC to operate and/or charge) may be removably coupled with the electrical outlet 62B. The second power splitter 18 provides the second output voltage to the device 26B when the second power splitter 18 is in an activated state.

In various implementations, the controller 20 may control operation of the second power splitter 18 by selectively activating or deactivating the second power splitter 18. For example, the controller 20 may turn off or may turn on the first switch 70-1, the second switch 70-2, the third switch 70-3, and the fourth switch 70-4. The controller 20 may selectively activate or deactivate the first transistor 72-1, the second transistor 72-2, the third transistor 72-3, and the fourth transistor 72-4. In various implementations, the first switch 70-1 and the second switch 70-2 are in a closed configuration (e.g., turned on) when the second power splitter 18 is in an activated state. The first switch 70-1 and the second switch 70-2 are in an open configuration (e.g., turned off) when the first power splitter 16 is in an activated state.

With reference to FIG. 4, in various implementations, the third switch 70-3 may be electrically connected to a first leg L1 and a second leg L2 of the OBC 12 and/or the fourth switch 70-4 may be electrically connected with a neutral leg of the OBC 12. The third switch 70 may be in a closed configuration and/or the fourth switch 70-4 may be in an open configuration when the second power splitter 18 is in an activated state.

With reference to FIG. 5, in some example configurations, the third switch 70-3 may be electrically connected to a third leg L3 of the OBC 12. In various implementations, the third switch 70-3 may be in an open configuration when the second power splitter 18a is in an activated state.

In various implementations, during operation of the electrical assembly 10, the input port 30 may receive electrical current (e.g., approximately 48 A), input voltage (e.g., approximately 220 V), and/or input power (e.g., approximately 11 kW) from the power source 24. In accordance with an external electrical device (e.g., device 26B) being connected to the electrical outlet 62B and the second power splitter 18 being in an activated state, the second power splitter 18 may provide the second output voltage (e.g., approximately 120V AC), a second output current (e.g., approximately 30A AC), and/or a second output power (e.g., approximately 3.6 kW) to the external electrical device while the OBC 12 simultaneously provides power (e.g., approximately 7.2 kW) to charge the at least one battery 14.

In various implementations, the electrical outlet 62B of the second power splitter 18 may be the same or may be different than the electrical outlet 62A of the first power splitter 16. In other words, in some implementations, the first power splitter 16 and the second power splitter 18 may both utilize (e.g., electrically communicate through) the electrical outlet 62A, and, in some implementations, the first power splitter 16 and the second power splitter 18 may both utilize (e.g., electrically communicate through) the electrical outlet 62B.

In various implementations, the controller 20 may determine whether to provide the first output voltage or the second output voltage to an external device (e.g., external device 26A, 26B) connected to an electrical outlet (e.g., electrical outlet 62A, 64B). For example, the controller 20 may determine which output voltage (e.g., the first output voltage or the second output voltage) is required for an electrical device (e.g., external device 26A, 26B) connected to an electrical outlet (e.g., electrical outlet 62A, 64B) based on a plug of the electrical device being connected with the electrical outlet. In various implementations, an electrical device (e.g., electrical device 26A) that requires the first output voltage (e.g., approximately 220 V AC) may use a European standard electrical plug. In various implementations, an electrical device (e.g., electrical device 26B) that requires the second output voltage (e.g., approximately 120 V AC) may use a North American standard electrical plug. The controller 20 may identify which plug is connected with the electrical outlet.

### Controller

In various implementations, the controller 20 includes an electronic controller and/or an electronic processor, such as a programmable microprocessor and/or microcontroller. The controller 20 may include an application specific integrated circuit (ASIC). The controller 20 may include a central processing unit (CPU), a memory (for example, a non-transitory computer-readable storage medium), and/or an input/output (I/O) interface. The controller 20 may perform various functions, including those described in greater detail herein, with appropriate programming instructions and/or code embodied in software, hardware, and/or other medium. The controller 20 may include a plurality of controllers. The controller 20 may be connected to a display, such as a touch screen.

### Vehicle

With reference to FIG. 1, the electrical assembly 10, the at least one battery 14, the first device 26A, and/or the second device 26B may be incorporated with and/or disposed in the vehicle 22. The vehicle 22 may include one or more of a variety of configurations. For example, a vehicle 22 may include a land vehicle, a passenger car, a van, a sport utility vehicle (SUV), a crossover, a truck (e.g., a pickup truck, a commercial truck, etc.), a bus, a watercraft, an aircraft (e.g., a plane, a helicopter, etc.), and/or a combination thereof (e.g., a vehicle for land and water, a vehicle for air and water, etc.), among others.

### Power Source

In various implementations, the power source 24 may be associated with the power grid, a solar panel, a power converter, and/or an outlet, among others. In various implementations, residential, commercial, and/or public charging infrastructure may be used to connect the vehicle 22 (e.g., the input port 30) with the power source 24. In some examples, the charging infrastructure may include a charging station, a charging cable, and/or a charging connector, among others.

### External Electrical Devices

In various implementations, an external electrical device (e.g., external electrical device 26A, 26B) includes one or more of a variety of configurations. For example, an external electrical device may include an electrical device, an electronics device, a cell phone, a tablet, a computer, a laptop, a video game system, a television, an e-bike, a power tool battery, a power tool, and/or a household appliance, among others.

### Flowchart

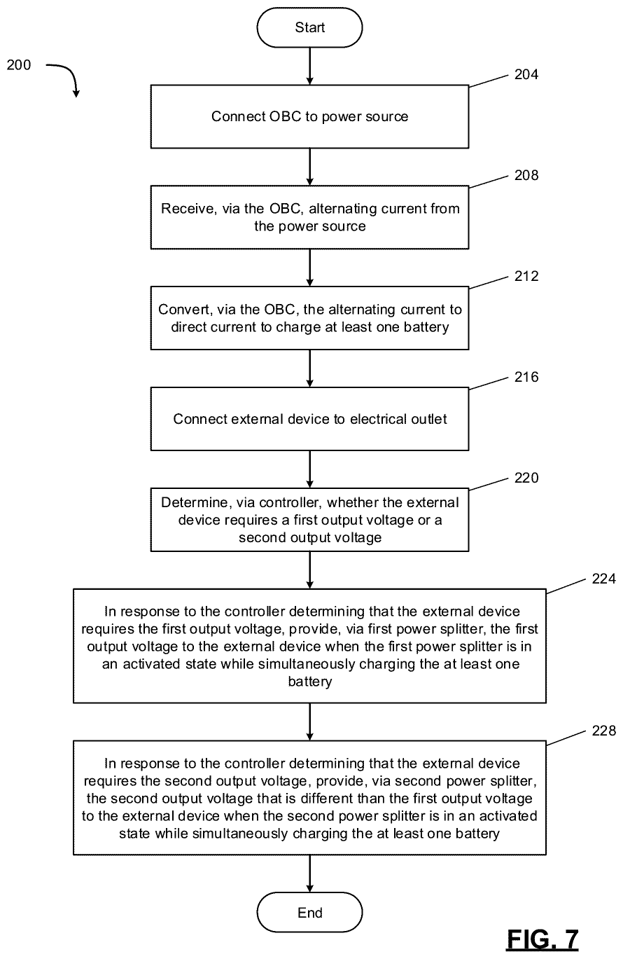

FIG. 7 is a flowchart of an example method 200 for operating an electrical assembly 10. In various implementations, the electrical assembly 10 may include an onboard charger (OBC) 12, at least one battery 14 electrically connected with the OBC 12, a first power splitter 16 electrically connected with the OBC 12, a second power splitter 18 electrically connected with the OBC 12, an electrical outlet (e.g., electrical outlet 62A, 62B) electrically connected with the first power splitter 16 and the second power splitter 18, and a controller 20 electrically connected with the OBC 12, the first power splitter 16, the second power splitter 18, and the electrical outlet. The method 200 may begin at 204. At 204, a user may connect the OBC 12 to a power source 24. The method 200 may proceed to 208. At 208, the OBC 12 may receive alternating current from the power source 24. In some example configurations, the OBC 12 may receive an input voltage (e.g., approximately 220 V AC) from the power source. The method 200 may proceed to 212.

At 212, the OBC 12 may convert the alternating current to direct current to charge the at least one battery 14. The method 200 may proceed to 216. At 216, a user may connect an external device (e.g., external device 26A, 26B) to the electrical outlet. The method 200 may proceed to 220.

At 220, the controller 20 may determine whether the external device requires a first output voltage (e.g., approximately 220 V AC) or a second output voltage (e.g., approximately 120 V AC). For example, the controller 20 may determine which output voltage (e.g., the first output voltage or the second output voltage) is required for an electrical device (e.g., external device 26A, 26B) connected to an electrical outlet (e.g., electrical outlet 62A, 64B) based on a plug of the electrical device being connected with the electrical outlet. The method 200 may proceed to 224.

At 224, in response to the controller 20 determining that the external device requires the first output voltage, the first power splitter 16 may provide the first output voltage to the external device when the first power splitter 16 is in an activated state while simultaneously charging the at least one battery 14. The method 200 may proceed to 228.

At 228, in response to the controller 20 determining that the external device requires the second output voltage, the second power splitter 18 may provide the second output voltage that is different than the first output voltage to the external device when the second power splitter 18 is in an activated state while simultaneously charging the at least one battery 14. Then the method 200 may end.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. In the written description and claims, one or more steps within a method may be executed in a different order (or concurrently) without altering the principles of the present disclosure. Similarly, one or more instructions stored in a non-transitory computer-readable medium may be executed in a different order (or concurrently) without altering the principles of the present disclosure. Unless indicated otherwise, numbering or other labeling of instructions or method steps is done for convenient reference, not to indicate a fixed order.

Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship encompasses a direct relationship where no other intervening elements are present between the first and second elements as well as an indirect relationship where one or more intervening elements are present between the first and second elements.

As noted below, the term “set” generally means a grouping of one or more elements. However, in various implementations a “set” may, in certain circumstances, be the empty set (in other words, the set has zero elements in those circumstances). As an example, a set of search results resulting from a query may, depending on the query, be the empty set. In contexts where it is not otherwise clear, the term “non-empty set” can be used to explicitly denote exclusion of the empty set—that is, a non-empty set will always have one or more elements.

A “subset” of a first set generally includes some of the elements of the first set. In various implementations, a subset of the first set is not necessarily a proper subset: in certain circumstances, the subset may be coextensive with (equal to) the first set (in other words, the subset may include the same elements as the first set). In contexts where it is not otherwise clear, the term “proper subset” can be used to explicitly denote that a subset of the first set must exclude at least one of the elements of the first set. Further, in various implementations, the term “subset” does not necessarily exclude the empty set. As an example, consider a set of candidates that was selected based on first criteria and a subset of the set of candidates that was selected based on second criteria; if no elements of the set of candidates met the second criteria, the subset may be the empty set. In contexts where it is not otherwise clear, the term “non-empty subset” can be used to explicitly denote exclusion of the empty set.

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” can be replaced with the term “controller” or the term “circuit.” In this application, the term “controller” can be replaced with the term “module.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); processor hardware (shared, dedicated, or group) that executes code; memory hardware (shared, dedicated, or group) that is coupled with the processor hardware and stores code executed by the processor hardware; other suitable hardware components that provide the described functionality; or a combination of some or all of the above, such as in a system-on-chip.

The module may include one or more interface circuits. In some examples, the interface circuit(s) may implement wired or wireless interfaces that connect to a local area network (LAN) or a wireless personal area network (WPAN). Examples of a LAN are Institute of Electrical and Electronics Engineers (IEEE) Standard 802.11-2020 (also known as the WIFI wireless networking standard) and IEEE Standard 802.3-2018 (also known as the ETHERNET wired networking standard). Examples of a WPAN are IEEE Standard 802.15.4 (including the ZIGBEE standard from the ZigBee Alliance) and, from the Bluetooth Special Interest Group (SIG), the BLUETOOTH wireless networking standard (including Core Specification versions 3.0, 4.0, 4.1, 4.2, 5.0, and 5.1 from the Bluetooth SIG).

The module may communicate with other modules using the interface circuit(s). Although the module may be depicted in the present disclosure as logically communicating directly with other modules, in various implementations the module may actually communicate via a communications system. The communications system includes physical and/or virtual networking equipment such as hubs, switches, routers, and gateways. In some implementations, the communications system connects to or traverses a wide area network (WAN) such as the Internet. For example, the communications system may include multiple LANs connected to each other over the Internet or point-to-point leased lines using technologies including Multiprotocol Label Switching (MPLS) and virtual private networks (VPNs).

In various implementations, the functionality of the module may be distributed among multiple modules that are connected via the communications system. For example, multiple modules may implement the same functionality distributed by a load balancing system. In a further example, the functionality of the module may be split between a server (also known as remote, or cloud) module and a client (or, user) module. For example, the client module may include a native or web application executing on a client device and in network communication with the server module.

Some or all hardware features of a module may be defined using a language for hardware description, such as IEEE Standard 1364-2005 (commonly called “Verilog”) and IEEE Standard 1076-2008 (commonly called “VHDL”). The hardware description language may be used to manufacture and/or program a hardware circuit. In some implementations, some or all features of a module may be defined by a language, such as IEEE 1666-2005 (commonly called “SystemC”), that encompasses both code, as described below, and hardware description.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

The memory hardware may also store data together with or separate from the code. Shared memory hardware encompasses a single memory device that stores some or all code from multiple modules. One example of shared memory hardware may be level 1 cache on or near a microprocessor die, which may store code from multiple modules. Another example of shared memory hardware may be persistent storage, such as a solid state drive (SSD) or magnetic hard disk drive (HDD), which may store code from multiple modules. Group memory hardware encompasses a memory device that, in combination with other memory devices, stores some or all code from one or more modules. One example of group memory hardware is a storage area network (SAN), which may store code of a particular module across multiple physical devices. Another example of group memory hardware is random access memory of each of a set of servers that, in combination, store code of a particular module. The term memory hardware is a subset of the term computer-readable medium.

The apparatuses and methods described in this application may be partially or fully implemented by a special-purpose computer created by configuring a general-purpose computer to execute one or more particular functions embodied in computer programs. Such apparatuses and methods may be described as computerized or computer-implemented apparatuses and methods. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special-purpose computer, device drivers that interact with particular devices of the special-purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective C, Swift, Haskell, Go, SQL, R, Lisp, Java®, Fortran, Perl, Pascal, Curl, OCaml, JavaScript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

The term non-transitory computer-readable medium does not encompass transitory electrical or electromagnetic signals propagating through a medium (such as on a carrier wave). Non-limiting examples of a non-transitory computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The term “set” generally means a grouping of one or more elements. The elements of a set do not necessarily need to have any characteristics in common or otherwise belong together. The phrase “at least one of A, B, and C” should be construed to mean a logical (A OR B OR C), using a non-exclusive logical OR, and should not be construed to mean “at least one of A, at least one of B, and at least one of C.” The phrase “at least one of A, B, or C” should be construed to mean a logical (A OR B OR C), using a non-exclusive logical OR.

The following Clauses provide an exemplary configuration for an electrical assembly and related methods, as described above.

Clause 1: An electrical assembly comprising: an onboard charger (OBC) configured to receive alternating current from a power source; and a power splitter electrically connected with the OBC and configured to provide an output voltage, wherein the electrical assembly is configured to simultaneously charge at least one battery and provide the output voltage.

Clause 2: The electrical assembly of clause 1, wherein: the OBC is configured to receive an input voltage from the power source; and the output voltage is less than the input voltage.

Clause 3: The electrical assembly of clause 1 or 2, wherein: the OBC is configured to receive up to 240V AC from the power source; and the output voltage is approximately 120V AC.

Clause 4: The electrical assembly of any of clauses 1 through 3, wherein: the OBC includes: an input port; and a rectifier electrically connected with the input port; the power splitter includes an inverter that is electrically connected with the rectifier; and the input port is removably coupled with the power source.

Clause 5: The electrical assembly of clause 4, wherein: the rectifier is configured to convert the alternating current received from the power source to direct current to charge the at least one battery; and the inverter is configured to convert the direct current from the rectifier to alternating current to produce the output voltage.

Clause 6: The electrical assembly of clause 4, wherein the power splitter includes: a first switch and a second switch electrically connected with the inverter; and an electrical outlet electrically connected with the first switch and the second switch.

Clause 7: The electrical assembly of clause 6, wherein the first switch and the second switch are in a closed configuration when the power splitter is in an activated state.

Clause 8: The electrical assembly of clause 6, wherein: an external device is removably coupled with the electrical outlet; and the power splitter is configured to provide the output voltage to the external device when the power splitter is in an activated state.

Clause 9: The electrical assembly of any of clauses 1 through 8, wherein the OBC is configured to electrically connect to an additional power splitter operable to provide an additional output voltage that is different than the output voltage.

Clause 10: The electrical assembly of clause 9, wherein: the OBC is configured to receive up to 240V AC from the power source; and the additional output voltage is approximately 220V AC.

Clause 11: The electrical assembly of clause 9, wherein: the OBC includes an input port; the input port is removably coupled with the power source; and the additional power splitter is electrically connected with the input port.

Clause 12: The electrical assembly of clause 11, wherein: the additional power splitter includes: a first switch and a second switch electrically connected with the input port; and an electrical outlet electrically connected with the first switch and the second switch; and the first switch and the second switch are in a closed configuration when the additional power splitter is in an activated state.

Clause 13: The electrical assembly of clause 12, wherein: an external device is removably coupled with the electrical outlet; and the additional power splitter is configured to provide the additional output voltage to the external device when the additional power splitter is in an activated state.

Clause 14: A vehicle comprising: the electrical assembly of any of clauses 1 through 13.

Clause 15: An electrical assembly comprising: a power splitter configured to electrically connect to an onboard charger (OBC) and provide an output voltage, wherein: the OBC is configured to receive alternating current from a power source, and the electrical assembly is configured to simultaneously charge at least one battery and provide the output voltage.

Clause 16: The electrical assembly of clause 15, wherein: the OBC includes: an input port; and a rectifier electrically connected with the input port; the power splitter includes an inverter that is electrically connected with the rectifier; and the input port is removably coupled with the power source.

Clause 17: The electrical assembly of clause 16, wherein: the rectifier is configured to convert the alternating current received from the power source to direct current to charge the at least one battery; and the inverter is configured to convert the direct current from the rectifier to alternating current to produce the output voltage.

Clause 18: The electrical assembly of clause 16, wherein: the power splitter includes: a first switch and a second switch electrically connected with the inverter; and an electrical outlet electrically connected with the first switch and the second switch; and the first switch and the second switch are in a closed configuration when the power splitter is in an activated state.

Clause 19: The electrical assembly of any of clauses 15 through 18, wherein the OBC is configured to electrically connect to an additional power splitter operable to provide an additional output voltage that is different than the output voltage.

Clause 20: The electrical assembly of clause 19, wherein: the additional power splitter includes: a first switch and a second switch electrically connected with an input port of the OBC; and an electrical outlet electrically connected with the first switch and the second switch; and the first switch and the second switch are in a closed configuration when the additional power splitter is in an activated state.

What is claimed is:

1. An electrical assembly comprising:
an onboard charger (OBC) configured to receive alternating current from a power source; and
a power splitter electrically connected with the OBC and configured to provide an output voltage,
wherein the electrical assembly is configured to simultaneously charge at least one battery and provide the output voltage.

2. The electrical assembly of claim 1 wherein:
the OBC is configured to receive an input voltage from the power source; and
the output voltage is less than the input voltage.

3. The electrical assembly of claim 1 wherein:
the OBC is configured to receive up to 240V AC from the power source; and
the output voltage is approximately 120V AC.

4. The electrical assembly of claim 1 wherein:
the OBC includes:
an input port; and
a rectifier electrically connected with the input port;
the power splitter includes an inverter that is electrically connected with the rectifier; and
the input port is removably coupled with the power source.

5. The electrical assembly of claim 4 wherein:
the rectifier is configured to convert the alternating current received from the power source to direct current to charge the at least one battery; and
the inverter is configured to convert the direct current from the rectifier to alternating current to produce the output voltage.

6. The electrical assembly of claim 4 wherein the power splitter includes:
a first switch and a second switch electrically connected with the inverter; and
an electrical outlet electrically connected with the first switch and the second switch.

7. The electrical assembly of claim 6 wherein the first switch and the second switch are in a closed configuration when the power splitter is in an activated state.

8. The electrical assembly of claim 6 wherein:
an external device is removably coupled with the electrical outlet; and
the power splitter is configured to provide the output voltage to the external device when the power splitter is in an activated state.

9. The electrical assembly of claim 1 wherein the OBC is configured to electrically connect to an additional power splitter operable to provide an additional output voltage that is different than the output voltage.

10. The electrical assembly of claim 9 wherein:
the OBC is configured to receive up to 240V AC from the power source; and
the additional output voltage is approximately 220V AC.

11. The electrical assembly of claim 9 wherein:
the OBC includes an input port;
the input port is removably coupled with the power source; and
the additional power splitter is electrically connected with the input port.

12. The electrical assembly of claim 11 wherein:
the additional power splitter includes:
a first switch and a second switch electrically connected with the input port; and
an electrical outlet electrically connected with the first switch and the second switch; and
the first switch and the second switch are in a closed configuration when the additional power splitter is in an activated state.

13. The electrical assembly of claim 12 wherein:
an external device is removably coupled with the electrical outlet; and
the additional power splitter is configured to provide the additional output voltage to the external device when the additional power splitter is in an activated state.

14. A vehicle comprising:
the electrical assembly of claim 1.

15. An electrical assembly comprising:
a power splitter configured to electrically connect to an onboard charger (OBC) and provide an output voltage, wherein:
the OBC is configured to receive alternating current from a power source, and
the electrical assembly is configured to simultaneously charge at least one battery and provide the output voltage.

16. The electrical assembly of claim 15 wherein:
the OBC includes:
an input port; and
a rectifier electrically connected with the input port;
the power splitter includes an inverter that is electrically connected with the rectifier; and
the input port is removably coupled with the power source.

17. The electrical assembly of claim 16 wherein:
the rectifier is configured to convert the alternating current received from the power source to direct current to charge the at least one battery; and
the inverter is configured to convert the direct current from the rectifier to alternating current to produce the output voltage.

18. The electrical assembly of claim 16 wherein:
the power splitter includes:
a first switch and a second switch electrically connected with the inverter; and
an electrical outlet electrically connected with the first switch and the second switch; and
the first switch and the second switch are in a closed configuration when the power splitter is in an activated state.

19. The electrical assembly of claim 15 wherein the OBC is configured to electrically connect to an additional power splitter operable to provide an additional output voltage that is different than the output voltage.

20. The electrical assembly of claim 19 wherein:
the additional power splitter includes:
a first switch and a second switch electrically connected with an input port of the OBC; and
an electrical outlet electrically connected with the first switch and the second switch; and
the first switch and the second switch are in a closed configuration when the additional power splitter is in an activated state.
